(19) United States
(12) Patent Application Publication
(10) Pub. No.: US 2004/0052885 A1
(43) Pub. Date: Mar. 18, 2004

(54) Mold roll for an apparatus fabricating vehicle mat sheets having non-skid protrusions

(76) Inventor: Ki-Bong Lee, Seoul (KR)

Correspondence Address: Ladas & Parry, 26 West 61st Street, New York, NY, 10023, US

(21) Appl. No.: 10/378,426

(22) Filed: Mar. 3, 2003

(30) Foreign Application Priority Data
Sep. 18, 2002 (KR) 20-2002-28056
Sep. 18, 2002 (KR) 20-2002-28057

(51) Int. Cl. B29C 43/24

(52) U.S. Cl. 425/112; 425/369

(57) ABSTRACT

The present invention relates to a mold roll enabling good-quality non-skid conical protrusions to be formed on the bottom surface of the base sheet which is a raw material for a vehicle mat, which further comprises air recesses formed to be extended from the bottoms of the grooves formed in the radius direction on the outer circumference of the mold roll, and for accommodating air remaining in the grooves when the base sheet is pressed into the grooves of the mold roll, in an apparatus fabricating a vehicle mat sheet that has a guide roll for guiding a base sheet extruded in a sheet shape with a gel-state thermoplastic resin through an extruder and carpet supplied from a side, a mold roll for molding conical protrusions on the bottom surface of the base sheet, a carpet-adhering roll forming a pair with the mold roll to press and adhere the carpet on the top surface of the base sheet.

### BACKGROUND OF THE INVENTION

1. Field of the Invention

The present invention relates to a mold roll forming a mat sheet which is a raw material for mats covering the interior floor of a vehicle, and more particularly to a mold roll of an apparatus fabricating a vehicle mat sheet having non-skid protrusions wherein the vehicle mat sheet has good-quality non-skid conical protrusions on the bottom surface of a base sheet.

2. Description of the Prior Art

A mat sheet to be described hereinafter refers to a mat raw material fabricated by extruding a gel-state thermoplastic resin in a sheet shape to form a base sheet, forming non-skid protrusions on the bottom surface of the base sheet, and adhering carpet on the top surface of the base sheet.

The thermoplastic resin may be ethylene-vinyl acetate copolymer (EVA), polyesthylene (PE), polyurethane (PU), styrene-buadiene-styren block compolymer (SBS), thermoplastic elastomer-olefinic (TPO or TPE-O), and so on.

A vulcanized rubber base sheet on the surface of which carpet is adhered is used for a vehicle mat, and, as shown in FIG. 8, a mat a is cut out in a mat shape and the rim around the mat a is sewing-treated and combined together with carpet so that the carpet is prevented from releasing from the mat a.

Further, as disclosed in Republic of Korea Utility Model Registration No. 150628, the vehicle mat may be a mat molded to have carpet adhered on its surface by vulcanizing operations when heating upper and lower convexoconcave molds mounted to a press and, at the same time, to have non-skid conical protrusions formed on its bottom surface.

FIG. 1 is a view for schematically showing a main part of a general apparatus fabricating a vehicle mat sheet.

As shown in FIG. 1, the main part of a general apparatus includes a guide roll 1 for guiding a base sheet c formed by extruding a gel-state thermoplastic resin mass in a sheet shape through an extruder and carpet d supplied from a side, a mold roll 3 for molding non-skid conical protrusions on the bottom surface of the base sheet c, and a carpet-adhering roll 2 forming a pair with the mold roll 3 to press and adhere the carpet d on the top surface of the base sheet c.

At this time, the rotation shafts of the guide roll 1, mold roll 3, carpet-adhering roll 2 are all tube-shaped shafts through which cooling water flows to cool the base sheet c rolling and passing over the rolls 1, 2, and 3.

In the meantime, as shown in FIG. 2, grooves 5 for forming conical protrusions are formed in an orderly manner in the radius direction on the circumferential surface of the conventional mold roll 3, and the grooves 5 are formed to be appropriate for molding conical protrusions of a height less than 4 mm.

Accordingly, it is difficult to secure the reliability of a base sheet product of thermoplastic resin for mats having conical protrusions higher than 5 mm by using the conventional mold roll as above.

Even though there exists a difference of 1 mm only in number between a 4 mm-high conical protrusion and a 5 mm-conical protrusion, an occasion may occur that a tip portion of a conical protrusion is stuck and cut off in a groove when the base sheet is to be released from the mold roll, and defective protrusion moldings frequently occur since air existing between the grooves and the base sheet pressed into the grooves as a portion of the base sheet is pressed into the grooves is stuck rather than flowing out of the grooves and eventually prevents the base sheet from being pressed into the bottoms of the grooves for protrusion moldings.

Therefore, in a mold roll for an apparatus continuously supplying a sheet-shaped base sheet and fabricating a mat sheet having non-skid conical protrusions formed on its bottom surface of the base sheet and carpet adhered on the top surface of the base sheet, an apparatus enabling the mass production of a mat sheet having conical protrusions larger in size than regular ones if requested is desperately required.

### SUMMARY OF THE INVENTION

Accordingly, it is an object of the present invention to provide a mold roll for an apparatus fabricating a vehicle mat sheet having non-skid protrusions wherein it can form good-quality non-skid conical protrusions higher than 5 mm on the bottom of a base sheet while pressing and adhering carpet on the base sheet for the mat sheet.

It is another object of the present invention to provide a mold roll for an apparatus fabricating a vehicle mat sheet having non-skid protrusions wherein it can prevent defective moldings of conical protrusions from being formed due to the interference of air remaining in grooves as a gel-state base sheet is pressed into the grooves, and prevent the conical protrusions from being damaged when the protrusions are released from the grooves.

It is yet another object of the present invention to provide a mold roller for an apparatus fabricating a vehicle mat sheet having non-skid protrusions wherein space accommodating air remaining on contact surface of the mold roll is secured when a base sheet is closely contacted on the outer circumference of the mold roll between the grooves to enhance the contact of the mold roll and the base sheet, so that the molding property between the conical protrusions on the bottom surface of the base sheet can be improved.

It is a further object of the present invention to provide a mold roll for an apparatus fabricating a vehicle mat sheet having non-skid protrusions wherein it can form non-skid conical protrusions higher than 5 mm only in an area except for a sewing-treat region of a mat on the bottom surface of a base sheet while pressing and adhering carpet on the top surface of the base sheet.

In order to achieve the above objects, a mold roll for an apparatus fabricating a vehicle mat sheet having non-skid protrusions in which the apparatus has a guide roll for guiding a base sheet extruded in a sheet shape with a gel-state thermoplastic resin through an extruder and carpet supplied from a side, a mold roll for molding conical protrusions on the bottom surface of the base sheet, a carpet-adhering roll forming a pair with the mold roll to press and adhere the carpet on the top surface of the base sheet, comprises air recesses formed to be extended from the bottoms of the grooves formed in the radius direction on the outer circumference of the mold roll, and for accommodating air remaining in the grooves when the base sheet is pressed into the grooves of the mold roll.

Preferably, the grooves are formed in a depth ranging from 5 mm to 6 mm.

Preferably, the mold roll further comprises minute recesses formed on the surface of the mold roll between the adjacent grooves, and for accommodating air remaining on a contact surface of the mold roll when the base sheet comes in close contact with the outer circumference of the mold roll between the grooves.

In order to achieve the above objects, a mold roll for an apparatus fabricating a vehicle mat sheet having non-skid protrusions in which the apparatus has a guide roll for guiding a base sheet extruded in a sheet shape with a gel-state thermoplastic resin through an extruder and carpet supplied from a side, a mold roll having grooves for molding conical protrusions on the bottom surface of the base sheet, a carpet-adhering roll forming a pair with the mold roll to press and adhere the carpet on the top surface of the base sheet, comprises a mold roll having mat cutting indication rims formed on the outer circumference thereof, and the grooves are formed in areas only except for sewing-treat regions of mats.

Preferably, the mold roll has the mat cutting indication rims formed for a set of two mats on the outer circumference thereof, and the grooves are formed in areas only except for the sewing-treat regions of the mats.

Preferably, the mold roll has the mat cutting indication rims formed for a set of four mats on the outer circumference thereof, and the grooves are formed in areas only except for the sewing-treat regions of the mats.

Preferably, the mold roll further comprises minute recesses formed on the surface of the mold roll around the grooves in the areas of the mat cutting indication rims, and for accommodating air remaining on a contact surface of the mold roll when the base sheet comes in close contact with the outer circumference of the mold roll between the grooves.

### BRIEF DESCRIPTION OF THE DRAWINGS

The above objects and other features of the present invention will become more apparent by describing in detail a preferred embodiment thereof with reference to the attached drawing, in which:

FIG. 1 is a view for schematically showing a main part of a general apparatus fabricating a vehicle mat sheet;

FIG. 2 is a perspective view for showing a conventional mat sheet mold roll;

FIG. 3 is a vertically cross-sectioned view of a model roll according to an embodiment of the present invention;

FIG. 4 is an enlarged view of a portion marked “A” in FIG. 3;

FIG. 5 is a cross-sectioned view for partially showing a state that non-skid protrusions are molded on the bottom surface of a base sheet and carpet is adhered on the top surface of the base sheet by the mold roll according to an embodiment of the present invention;

FIG. 6 is an enlarged view of a portion marked “B” in FIG. 5;

FIG. 7 is a view for showing the bottom surface of a mat sheet molded according to an embodiment of the present invention;

FIG. 8 is a perspective view for showing a mat sewing-treated around its rim after a mat is cut out of a mat sheet molded according to an embodiment of the present invention;

FIG. 9 is a perspective view for showing a mold roll according to another embodiment of the present invention;

FIG. 10 is an expansion plan view of the mold roll shown in FIG. 9;

FIG. 11 is a perspective view for showing a mold roll according to yet another embodiment of the present invention;

FIG. 12 is an expansion plan view of the mold roll shown in FIG. 11;

FIG. 13 is a perspective view for showing a mold roll according to a further embodiment of the present invention;

FIG. 14 is an expansion plan view of the mold roll shown in FIG. 13; and

FIG. 15 is a view for showing the bottom surface of a mat sheet fabricated according to yet a further embodiment of the present invention.

### DETAILED DESCRIPTION OF THE PREFERRED EMBODIMENTS

Hereinafter, preferred embodiments of the present invention will be described with reference to the accompanying drawings, which is to describe in detail the present invention such that those skilled in the art can implement the present invention with ease, but not to define the technical spirit and scope of the present invention.

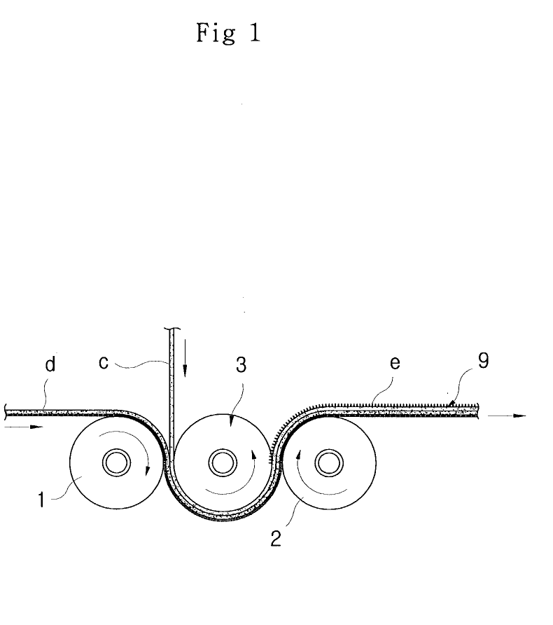

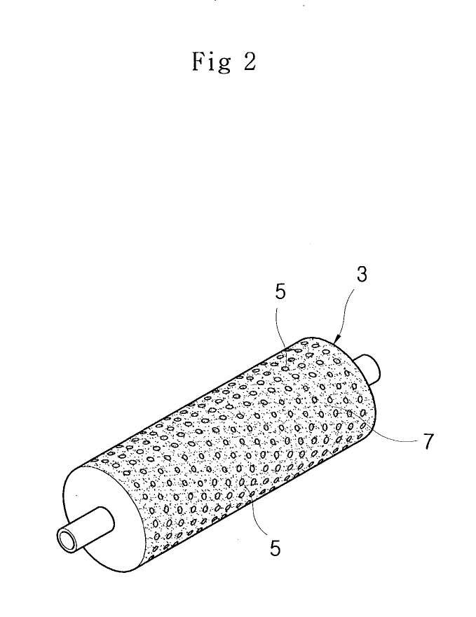

As shown in FIG. 1 and FIG. 2, the present invention is applied to an apparatus fabricating a vehicle mat sheet wherein the apparatus has the guide roll 1 for guiding a base sheet c supplied in a sheet shape after extruding a gel-state thermoplastic resin through an extruder and carpet d supplied from a side, a mold roll 3 for molding conical protrusions on the bottom surface of the base sheet c, and a carpet-adhering roll 2 forming a pair with the mold roll 3 to press and adhere the carpet d on the top surface of the base sheet c, and the rolls pertain to the technology generally used in the art so that the detailed descriptions of their structures and operations will be omitted.

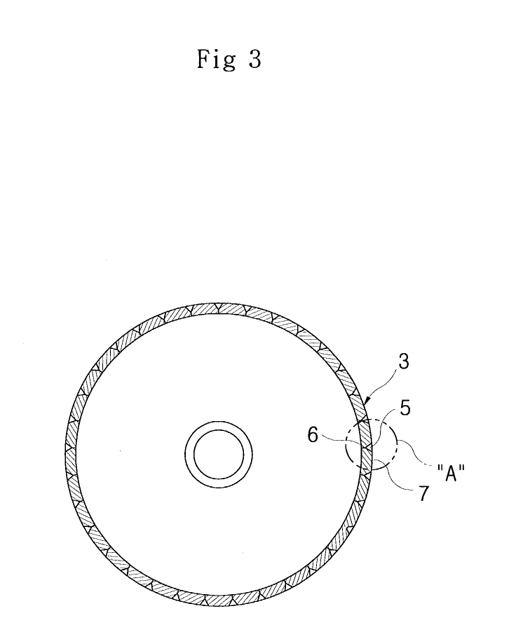

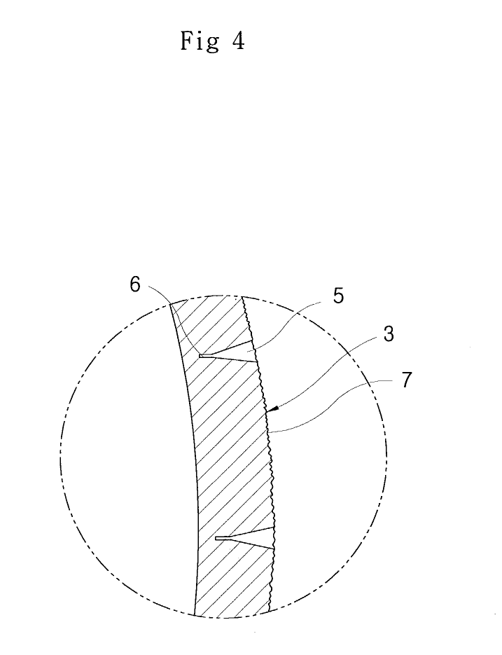

Accordingly, as shown in FIG. 3 to FIG. 6, a mold roll for an apparatus fabricating a vehicle mat sheet non-skid protrusions according to an embodiment of the present invention has grooves 5 formed in the radius direction on the outer circumference thereof in a depth ranging from 5 mm to 6 mm, and further includes air recesses 6 formed to be extended from the bottoms of the grooves 5 to accommodate air remaining in the grooves 5 when the base sheet c is pressed into the grooves 5.

At this time, the mold roll 3 further includes minute recesses 7 formed on the surface thereof between the grooves 5 to accommodate air remaining on the contact surfaces when the base sheet c is contacted with the outer circumference of the mold roll 3.

Hereinafter, a process for fabricating a mat sheet by the mold roll for an apparatus fabricating a vehicle mat sheet having non-skid protrusions according to an embodiment of the present invention will be described with reference to the accompanying drawings.

As shown in FIG. 1, the sheet-shaped base sheet c conveyed after extruded in an extruder (not shown) and a sheet-shaped carpet are conveyed by a conveyer (not shown), guided by the guide roll 1 and the mold roll 3 to become and move in close contact. The base sheet and the carpet d in close contact pass through between the mold roll 3 and the carpet-adhering roll 2 to adhere the carpet d on the top surface of the base sheet c, and, at the same time, non-skid conical protrusions e are molded on the bottom surface of the base sheet c by the grooves 5 formed in the radius direction on the outer circumference of the mold roll 3.

At this time, air stuck and remaining between the grooves 5 and the base sheet c pressed into the grooves 5 is accommodated in the air recesses 6 extended from the bottoms of the grooves 5. Accordingly, interference due to the air remaining in the grooves 5 is prevented when molding the protrusions e so that good-quality protrusions e longer than 5 mm can be formed on the bottom surface of the base sheet c.

The cross-sectioned area of a air recess is relatively very small compared to the cross-sectioned area of a groove 5 so that the air density in the air recess 6 becomes tightened. The buffering actions of the air remaining in the air recesses 6 can prevent the tips of the protrusions e formed on the bottom surface of the base sheet c from being pushed into the air recesses 6.

Further, when the protrusions e are released from the grooves 5, the air in the air recesses 6 removes a vacuum state inside the grooves 5, to thereby prevent defective products with the damaged or transformed tips of the protrusions e since the protrusions e are easily released from the grooves 5 and clearly treat the tips of the protrusions e.

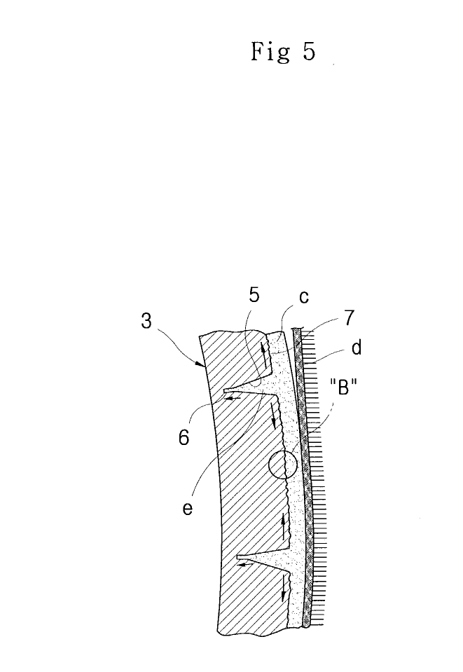

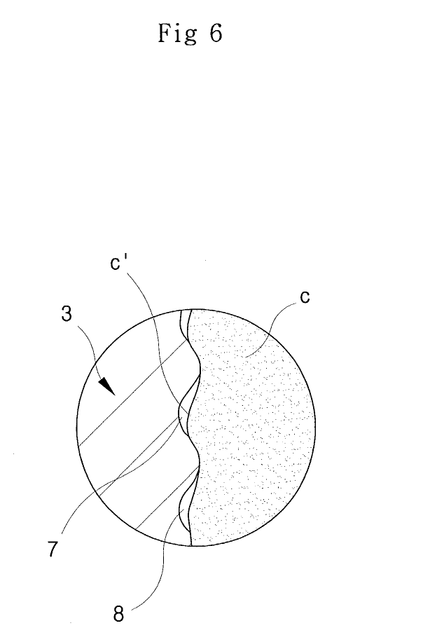

In the meantime, as shown in FIG. 5 and FIG. 6, base sheet c′, from the base sheet c contacted with the surface of the mold roll 3, in the minute recesses 7 formed between the adjacent grooves 5 can produce minute spaces 8 with the minute recesses 7.

Accordingly, the air flowing out of the grooves 5 when the base sheet c is pressed into the grooves 5 is accommodated in the minute spaces 8, or the air remaining in the region between the adjacent grooves 5 is accommodated in the minute spaces 8 rather than flowing out of the mold roll 3. Therefore, the mutual contact of the mold roll 3 and the base sheet c is improved so that the moldings of the protrusions e and the molding property of the bottom surface of the base sheet c can be enhanced regardless of a height of the protrusions e to be molded.

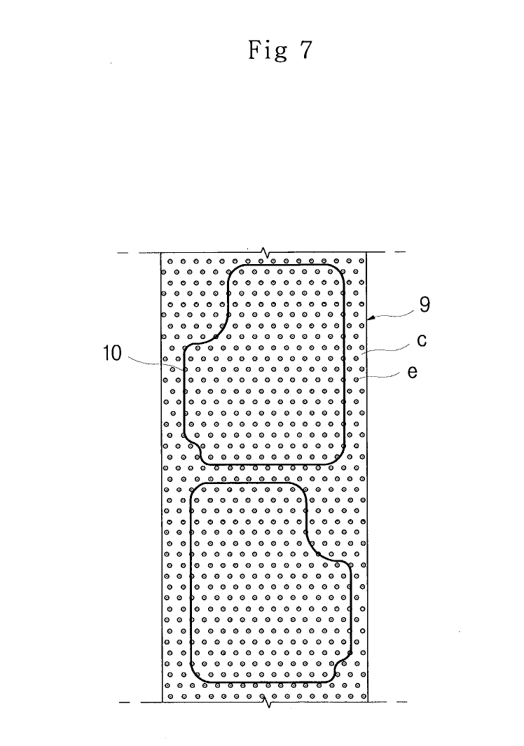

As shown in FIG. 7, a mat sheet 9 continuously fabricated as above is put into a press having a mold for cutting a mat out along a cutting line 10. If the press cuts the mat sheet 9 along the cutting line 10, a vehicle mat having the same shape as that inside the cutting line 10 is completed.

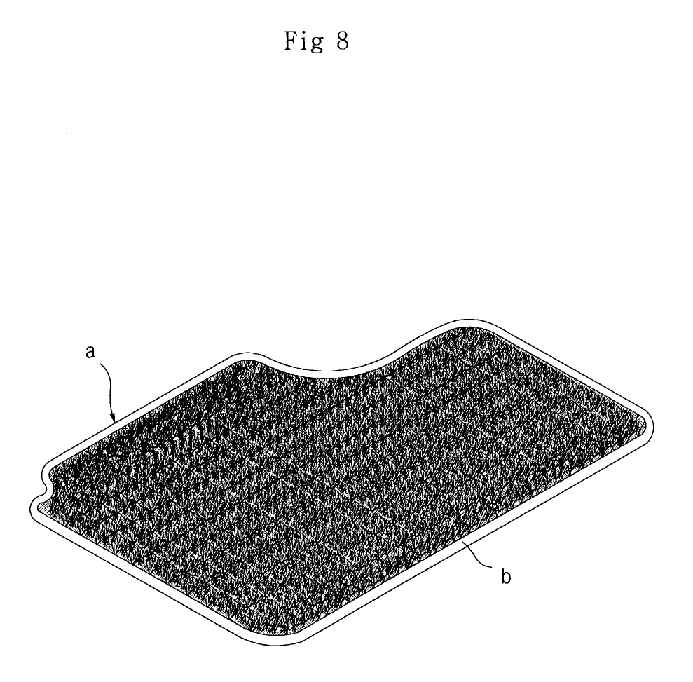

As shown in FIG. 8, even the base sheet c and the carpet d are adhered together as above, the rim of the cutout mat a can come off so that the mat a is sewn along the rim thereof.

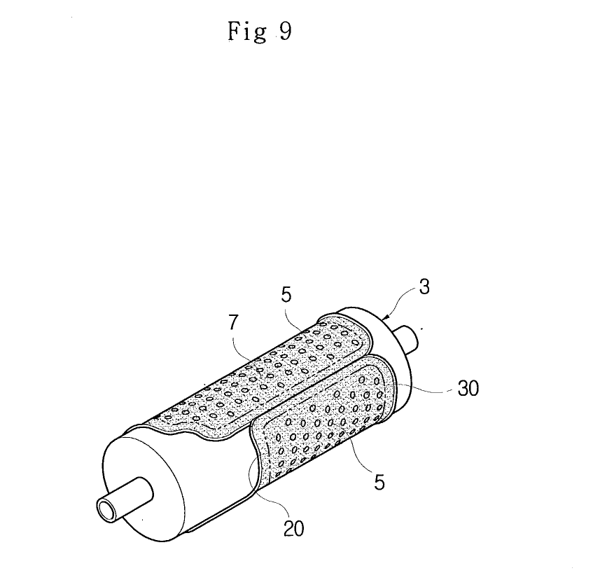

In the meantime, as shown in FIG. 9 to FIG. 14, an apparatus fabricating a mat sheet according to another embodiment of the present invention has the guide roll 1 for guiding a base sheet c extruded in a sheet shape with a gel-state thermoplastic resin through an extruder (not shown) and carpet d supplied from a side, a mold roll 3 for molding conical protrusions on the bottom surface, of the base sheet c, a carpet-adhering roll 2 forming a pair with the mold roll 3 to press and adhere the carpet on the top surface of the base sheet c, and air recesses 6 formed to be extended from the bottoms of the grooves 5 formed in the radius direction on the outer circumference of the mold roll 3, which are the same as the mold roll according to an embodiment of the present invention so detailed descriptions will be omitted.

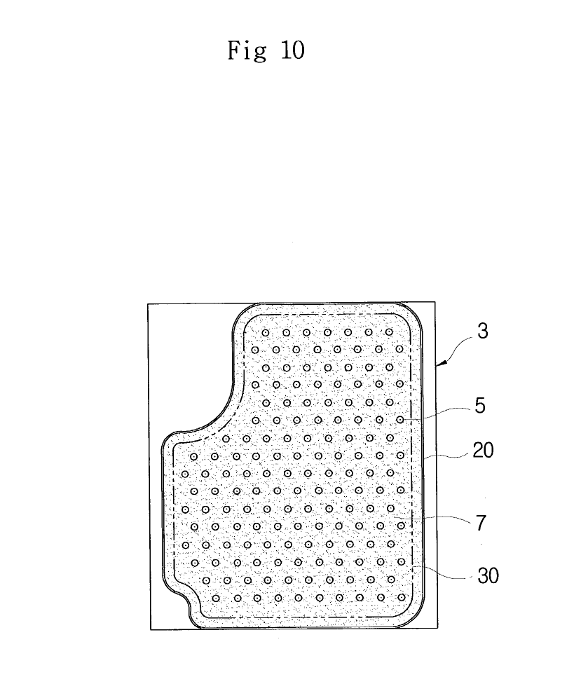

Accordingly, as shown in FIG. 9 and FIG. 10, a mold roll for an apparatus fabricating a vehicle mat sheet having non-skid protrusions according to another embodiment of the present invention has a mat cutting indication rim 20 formed on the outer circumference of the mold roll 3, and the grooves 5 having a depth ranging from 5 mm to 6 mm are formed only in the area except for a sewing-treat region between the inside of the mat cutting indication rim 20 and the virtual line 30.

When the carpet d is adhered on the top surface of the base sheet c while The sheet-shaped base sheet c passes between the mold roll 3 and the carpet-adhering roll 2, the mat cutting indication rim 20 maintains its contours by a pressure applied between the mold roll 3 and the carpet-adhering roll 2, and a cutting line 21 is marked on the bottom surface of the base sheet c to cut out a mat. The mold roll 3 molds one sheet of mat every one revolution.

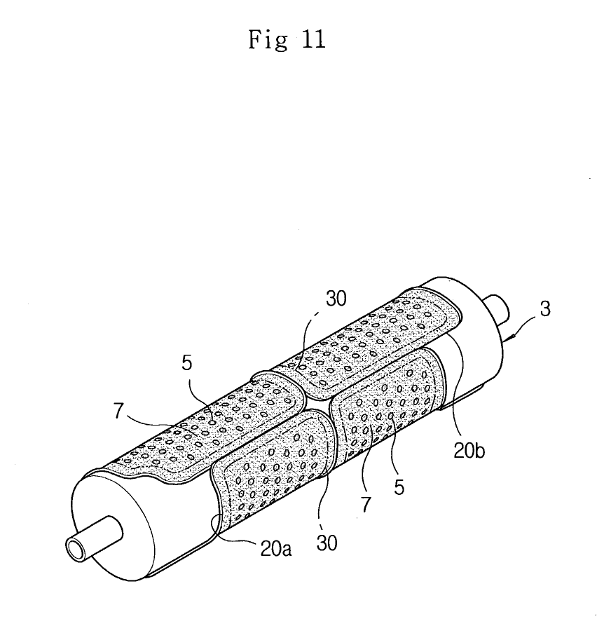

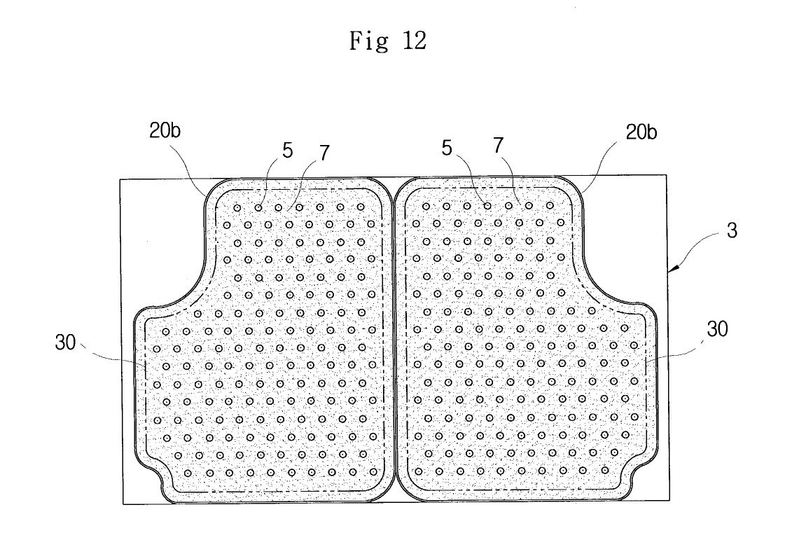

Further, as shown in FIG. 11 and FIG. 12, the mold roll 3 has mat cutting indication rims 20a and 20b formed for a set of two mats on the outer circumference thereof, and has the grooves 5 inside the area except for sewing-treat regions of the mats.

The mat cutting indication rims 20a and 20b are arranged in the bilateral symmetry on the mold roll 3, and the mold roll 3 produces two sheets of mat in the same shape every one revolution, which can be effectively used as mats for trucks with a driver's seat and a passenger's seat only.

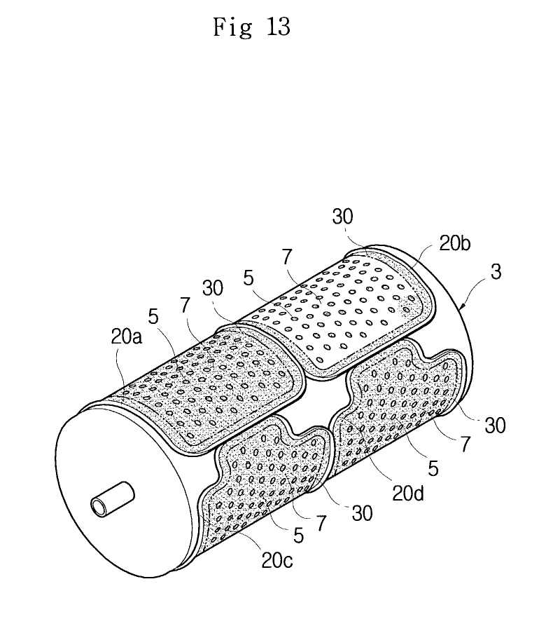

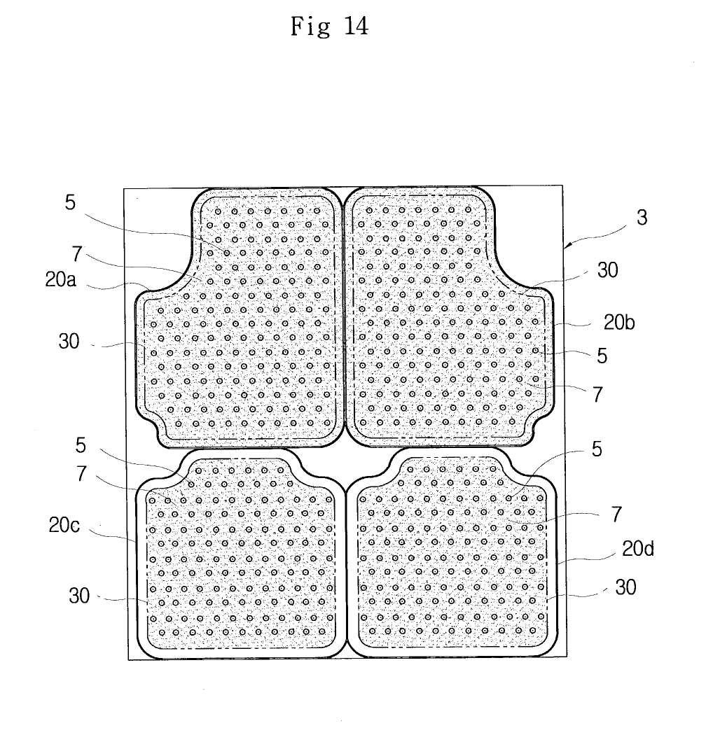

Further, as shown in FIG. 13 and FIG. 14, the mold roll 3 has mat cutting indication rims 20a, 20b, 20c, and 20d formed for a set of four mats on the outer circumference thereof, and has grooves 5 inside the area except for sewing-treat regions of the mats.

The mold roll 3 arranges the mat cutting indication rims 20a and 20b for the driver's and passenger's seats and the mat cutting indication rims 20c and 20d for the rear seats in pairs respectively so that the mold roll 3 enables a set of mats to be fabricated every one revolution. At this time, the mat cutting indication rims 20a and 20b, and 20c and 20d are arranged in dual rows so that the radius of the mold roll 3 increases accordingly.

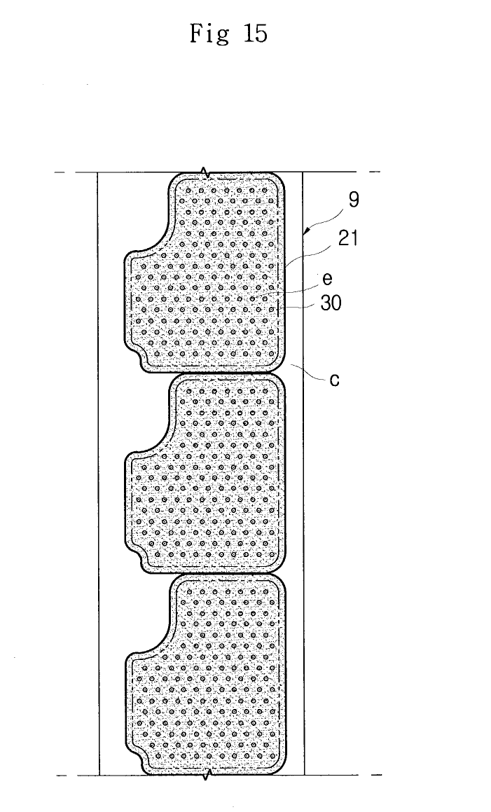

In the meantime, as shown in FIG. 15, the mat sheet 9 fabricated by the single-type mold roll 3 is cut by a press with a mold for cutting along the cutting line 21 to produce mats, and each mat formed with the base sheet c and the carpet d adhered together is sewing-treated along the rim thereof to prevent the carpet from coming off.

In the meantime, the mold roll 3 further includes minute recesses 7 formed on the surface thereof around the grooves 5 in the areas of the mat cutting indication rims 20, 20a and 20b, and 20a, 20b, 20c, and 20d to accommodate air remaining on the contact surface thereof when the base sheet c comes in close contact with the outer circumference of the mold roll 3 between the grooves 5, to thereby enhance the molding property of the bottom surface of the base sheet c between the protrusions.

The mold roll for an apparatus fabricating a vehicle mat sheet having non-skid protrusions according to the present invention has advantages as follows.

Non-skid conical protrusions longer than 5 mm are formed in good quality on the bottom surface of the base sheet while carpet is pressed and adhered on the top surface of the base sheet for a vehicle mat sheet, to thereby secure reliability.

Further, the mold roll can prevent defective moldings of conical protrusions from being formed due to the interference of air remaining in grooves as a gel-state base sheet is pressed into the grooves of the mold roll, and prevent the conical protrusions from being damaged when the protrusions are released from the grooves, to thereby reduce a defective product occurrence rate.

Further, space accommodating air remaining on contact surface of the mold roll is secured when a base sheet is closely contacted on the outer circumference of the mold roll between the adjacent grooves to enhance the contact of the mold roll and the base sheet, to thereby improve the molding property of the bottom surface of the base sheet.

Further, the mold roll can form non-skid conical protrusions higher than 5 mm only in an area except for a sewing-treat region of a mat on the bottom surface of a base sheet while pressing and adhering carpet on the top surface of the base sheet.

What is claimed is:

1. A mold roll for an apparatus fabricating a vehicle mat sheet having non-skid protrusions in which the apparatus has a guide roll for guiding a base sheet extruded in a sheet shape with a gel-state thermoplastic resin through an extruder and carpet supplied from a side, a mold roll for molding conical protrusions on the bottom surface of the base sheet, a carpet-adhering roll forming a pair with the mold roll to press and adhere the carpet on the top surface of the base sheet, comprising:
air recesses formed to be extended from the bottoms of the grooves formed in the radius direction on the outer circumference of the mold roll, and for accommodating air remaining in the grooves when the base sheet is pressed into the grooves of the mold roll.

2. The mold roll as claimed in claim 1, wherein the grooves are formed in a depth ranging from 5 mm to 6 mm.

3. The mold roll as claimed in claim 1, further comprising minute recesses formed on the surface of the mold roll between the adjacent grooves, and for accommodating air remaining on a contact surface of the mold roll when the base sheet comes in close contact with the outer circumference of the mold roll between the grooves.

4. A mold roll for an apparatus fabricating a vehicle mat sheet having non-skid protrusions in which the apparatus has a guide roll for guiding a base sheet extruded in a sheet shape with a gel-state thermoplastic resin through an extruder and carpet supplied from a side, a mold roll having grooves for molding conical protrusions on the bottom surface of the base sheet, a carpet-adhering roll forming a pair with the mold roll to press and adhere the carpet on the top surface of the base sheet, comprising a mold roll having mat cutting indication rims formed on the outer circumference thereof, and the grooves are formed in areas only except for sewing-treat regions of mats.

5. The mold roll as claimed in claim 4, wherein the mold roll has the mat cutting indication rims formed for a set of two mats on the outer circumference thereof, and the grooves are formed in areas only except for the sewing-treat regions of the mats.

6. The mold roll as claimed in claim 4, wherein the mold roll has the mat cutting indication rims formed for a set of four mats on the outer circumference thereof, and the grooves are formed in areas only except for the sewing-treat regions of the mats.

7. The mold roll as claimed in any of claims 4 to 6, wherein the grooves are formed in a depth ranging from 5 mm to 6 mm.

8. The mold roll as claimed in any of claims 4 to 6, further comprising air recesses formed to be extended from the bottoms of the grooves formed in the radius direction on the outer circumference of the mold roll, and for accommodating air remaining in the grooves when the base sheet is pressed into the grooves of the mold roll.

9. The mold roll as claimed in any of claims 4 to 6, further comprising minute recesses formed on the surface of the mold roll around the grooves in the areas of the mat cutting indication rims, and for accommodating air remaining on a contact surface of the mold roll when the base sheet comes in close contact with the outer circumference of the mold roll between the grooves.
